(19) United States
(12) Patent Application Publication
(10) Pub. No.: US 2002/0126631 A1
(43) Pub. Date: Sep. 12, 2002

(54) Packet service method in a mobile communication system

(75) Inventor: Sung-Won Lee, Songnam-shi (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., KYUNGKI-DO (KR)

(21) Appl. No.: 10/091,769

(22) Filed: Mar. 6, 2002

(30) Foreign Application Priority Data
Mar. 6, 2001 (KR) 2001/11487

(51) Int. Cl. H04Q 7/00

(52) U.S. Cl. 370/328; 455/560

(57) ABSTRACT

A packet service method in a mobile communication system. A BSC (Base Station Controller) adds a field containing time information necessary for packet transmission on a radio link to a header of a packet destined for an MS (Mobile Station) and transmits the packet to a BTS (Base station Transceiver Sub-system). The BTS stores the packet and determines whether the current time is an action time based on the time information set in the field of the packet. Then the BTS transmits the packet to the MS on a radio link.

### PRIORITY

This application claims priority to an application entitled “Packet Service Method in a Mobile Communication System” filed in the Korean Industrial Property Office on Mar. 6, 2001 and assigned Ser. No. 2001-11487, the contents of which are hereby incorporated by reference.

### BACKGROUND OF THE INVENTION

1. Field of the Invention

The present invention relates generally to a mobile communication system, and in particular, to a method for providing a packet service. More particularly, the present invention relates to an apparatus and method for implementing the soft handoff of packet voice and packet data services when a CN (Core Network) and a RAN (Radio Access Network) are configured using packet transmission technology such as IP (Internet Protocol) in IS-95A/B, IS-2000, GSM (Global System for Mobile communication), WCDMA (Wideband Code Division Multiple Access), and next generation wireless mobile communication networks.

2. Description of the Related Art

Mobile communication systems have moved from voice service-centered systems like IS-95A/B and GSM to packet data service-centered systems like UMTS (Universal Mobile Telecommunication System)/WCDMA and GPRS (General Packet Radio System). As wireless packet data service has acquired increasing significance, more and more data traffic is being serviced in a mobile communication system. In this context, voice and data service providers must provide and manage the current circuit-switched communication network for voice service and a packet-based IP data network as shown in FIG. 1.

Referring to FIG. 1, the current mobile communication system is comprised of a mobile station (MS) 101, base station transceiver sub-systems (BTSs, BTS-a and BTS-b) 102-a and 102-b, a base station controller (BSC) 103, a mobile switching center (MSC) 104, and a gateway (GW) 105. To provide voice and data services, the MSC 104 is connected to a PSTN (Public Switched Telephone Network) 106 and the GW 105 is connected to an Internet 107. Reference numeral 109 denotes a voice path and reference numeral 110 denotes a data path. A voice service is provided to the MS 101 via the path 109 leading from the PSTN 106 through the MSC 104, the BSC 103, and the BTS 102-a and a data service is provided to the MS 101 via the path 110 leading from the Internet 107 through the GW 105, the BSC 103, and the BTS 102-a.

A demand for supporting voice and data services with a single network structure other than the separated network structures shown in FIG. 1 has arisen from mobile communication service providers. A standardization work group is studying on an All-IP network for standardization, accommodating the demand. It is expected that an All-IP system will convert the existing circuit-switched network to an IP-based packet network and support voice and data services contemporaneously on the same packet network. The concept of the All-IP system is illustrated in FIG. 2. The circuit-switched mobile communication network, where dedicated circuits are assigned to users for call connections, transforms to the All-IP network by converting transmission protocol IPs and thus making mobile communication equipment function as IP nodes. In order to deliver voice and data services via the same path, IPs are configured between BTSs 202-a & 202-b and a BSC 203, and between the BSC 203 and a GW 204. However, the transformation of mobile networks to the All-IP network entails the following problems, which have not been encountered in the existing circuit-switched network.

As the BSC-GW and BTS-BSC links are converted according to IP packet architecture, congestion and routing that occur in a packet network increase time delay. This is because transmission/reception is carried out without intermediate processing on transmission/reception paths and most delays on a transmission path are physical propagation delays inherent to a transmission medium in the existing circuit-switched network, whereas the IP-based packet network cannot assuredly compensate for transmission delay and jitter (time displacement) generated during BSC-GW and BTS-BSC transmission due to time delay involved with packet processing and route determination in routers, and use of buffers on a transmission path. That is, voice traffic is delivered transparently between a BSC and a GW, and between a BTS and a BSC, without processing delay in nodes on transmission paths without jitter in the existing circuit-switched network, whereas the problems of IP packet buffering and transmission/processing delay during BSC-GW and BTS-BSC transmission face the future mobile communication network being an IP-based packet network.

The worst problem that might arise from the buffering is jitter during a soft handoff for an MS in communication with at least two BTSs as it roams, as illustrated in FIG. 3. Referring to FIG. 3, traffic that has arrived at the BSC 203 from the GW 204 is delivered to the BTSs 202-a and 202-b. If the current mobile communication network supports a voice service, BTS-BSC delay is very small. Thus, when an MS communicates with two BTSs, the traffic transmitted from a BSC at which an SDU (Selection & Distribution Unit) resides, arrives at the BTSs almost simultaneously and channel cards at the BTSs transmit the traffic with little delay on radio links. Therefore, the MS receives the same information from the two different legs and transmits the information with good quality to its application layer. On the other hand, due to buffering and processing delay in IP routers and congestion on the BTS-BSC links, the traffic may arrive at the BTSs 202-a and 202-b at very different time points in the IP packet-based mobile communication network as illustrated in FIG. 2. That is, the MS 201 may receive the same traffic at different time points from the BTSs 202-a and 202-b, which is called a delay jitter.

With a delay jitter, an MS, if it is a legacy terminal that does not operate by IP, should receive the same information from at least two BTSs at the same time in the nature of soft handoff, which is very difficult. If it is an IP terminal, the traffic with the same sequence number arrives at the application layer of the MS at different time points and the resulting redundant data reception causes a protocol malfunction. As a result, it is impossible to implement a soft handoff in a normal way.

### SUMMARY OF THE INVENTION

It is, therefore, an object of the present invention to provide a packet service method for effectively supporting the soft handoff of packet voice and packet data services in a mobile communication network using packet-based transmission technology.

The above and other objects are achieved by providing a packet service method in a mobile communication system. A BSC adds a field containing time information necessary for packet transmission on a radio link to a header of a packet destined for an MS and transmits the packet to a BTS. The BTS stores the packet and determines whether the current time is an action time based on the time information set in the field of the packet. Then the BTS transmits the packet to the MS on a radio link.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a network configuration for supporting circuit-switched voice and packet data services in a conventional mobile communication system;

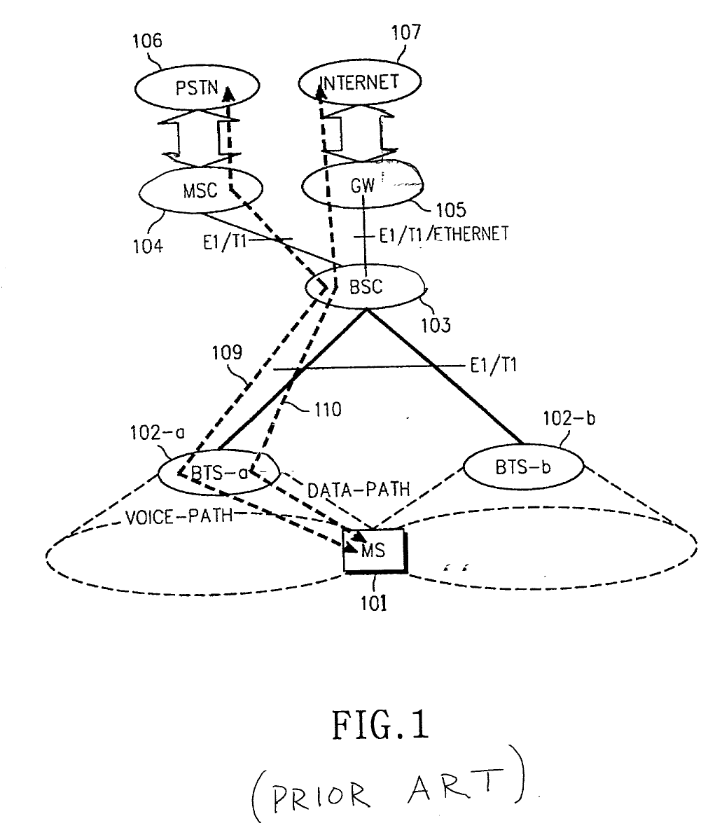

FIG. 2 illustrates an All-IP network configuration using IP-based packet transmission protocols in the conventional mobile communication system;

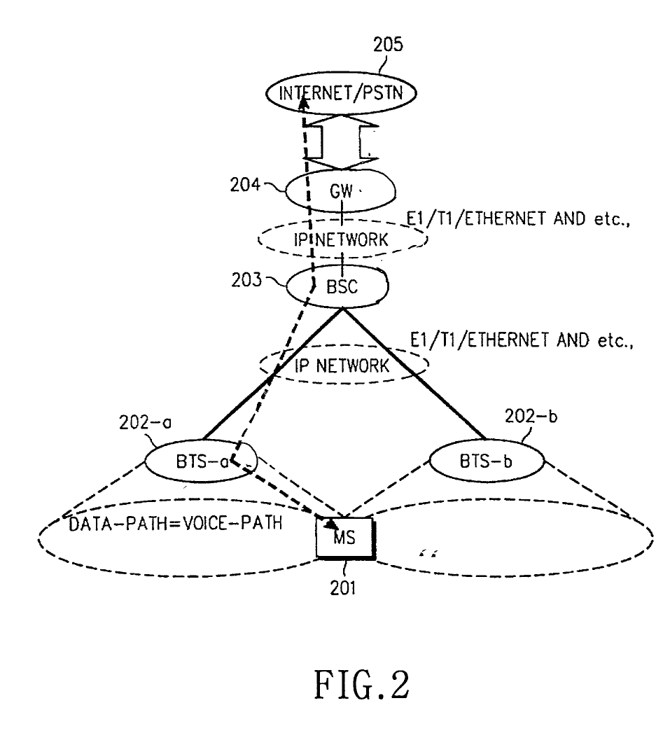

FIG. 3 illustrates legs for an MS when a soft handoff is implemented by conventional technology;

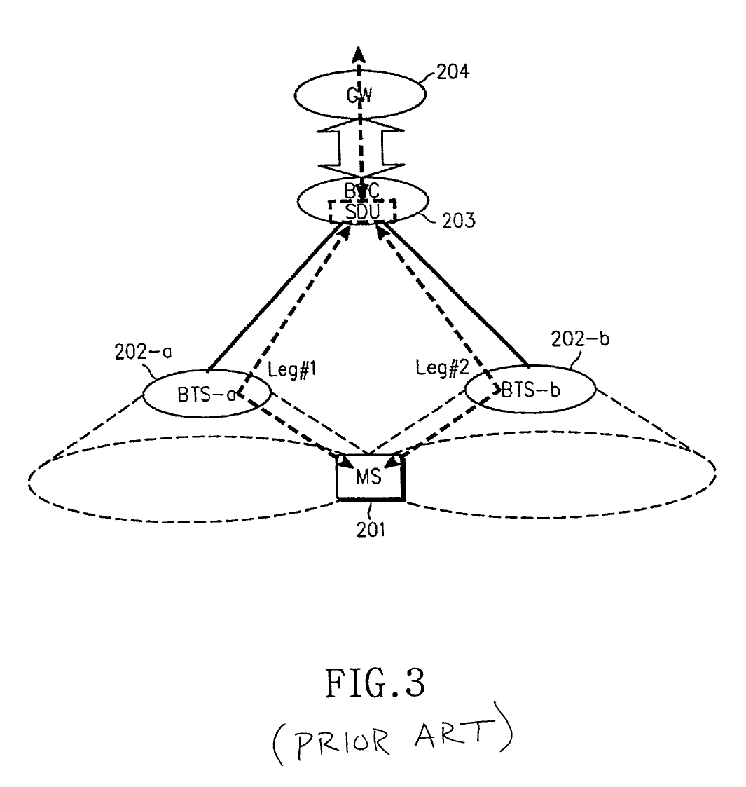

FIG. 4 illustrates a network configuration for a typical mobile communication system;

FIG. 5 illustrates a network configuration for a mobile communication system according to an embodiment of the present invention;

FIG. 6 is a block diagram of a BSC according to the embodiment of the present invention;

FIG. 7 is a block diagram of a BTS according to the embodiment of the present invention;

FIG. 8 is a detailed block diagram of a channel card shown in FIG. 7;

FIGS. 9A, 9B and 9C illustrate control messages exchanged for negotiations between the BSC/SPHsdu and the BTS/SPHbts according to the embodiment of the present invention;

FIGS. 10A and l0B illustrate negotiation procedures between the BSC/SPHsdu and the BTS/SPHbts according to the embodiment of the present invention;

FIGS. 11A to 11D illustrate the structures of packets transmitted between the BSC/SPHsdu and the BTS/SPHbts when an SEQ scheme is not used according to the embodiment of the present invention;

FIGS. 12A to 12D illustrate the structures of packets transmitted between the BSC/SPHsdu and the BTS/SPHbts when the SEQ scheme is used according to the embodiment of the present invention;

FIG. 13 is a flowchart illustrating packet processing for forward transmission at a TR-Tx mode in the BTS/SPHbts according to the embodiment of the present invention;

FIG. 14 is a flowchart illustrating packet processing for forward transmission at TF-Tx and TG-Tx modes in the BTS/SPHbts according to the embodiment of the present invention;

FIG. 15 is a flowchart illustrating packet processing for forward transmission at a DT-Tx mode in the BTS/SPHbts according to the embodiment of the present invention;

FIG. 16 is a flowchart illustrating packet processing for forward transmission at TFwtDT-Tx and TGwtDT-Tx modes in the BTS/SPHbts according to the embodiment of the present invention;

FIG. 17 is a flowchart illustrating packet processing for forward transmission in the BSC/SPHsdu according to the embodiment of the present invention;

FIG. 18 is a flowchart illustrating packet processing for reverse transmission in the BSC/SPHbts according to the embodiment of the present invention;

FIG. 19 is a flowchart illustrating packet processing for reverse transmission in the BSC/SPHsdu when the SEQ scheme is not used according to the embodiment of the present invention; and

FIG. 20 is a flowchart illustrating packet processing for reverse transmission in the BSC/SPHsdu when the SEQ scheme is used according to the embodiment of the present invention.

### DETAILED DESCRIPTION OF THE PREFERRED EMBODIMENT

A preferred embodiment of the present invention will be described hereinbelow with reference to the accompanying drawings. In the following description, well-known functions or constructions are not described in detail since they would obscure the invention in unnecessary detail.

The present invention provides a packet service method that effectively supports the soft handoff of packet voice and packet data services in a wireless mobile network (e.g., All-IP) using packet-based transmission technology. The present invention is applicable to soft handoff on both the forward and reverse links irrespective of using legacy terminals or future IP terminals. The present invention operates independently of lower-layer protocols. A receiver according to the present invention extracts data with the best quality among pieces of information received from a plurality of legs during a soft handoff. Yet, the present invention is not limited to soft handoff and can be used with packet transmission technology for a packet-based wireless mobile communication network.

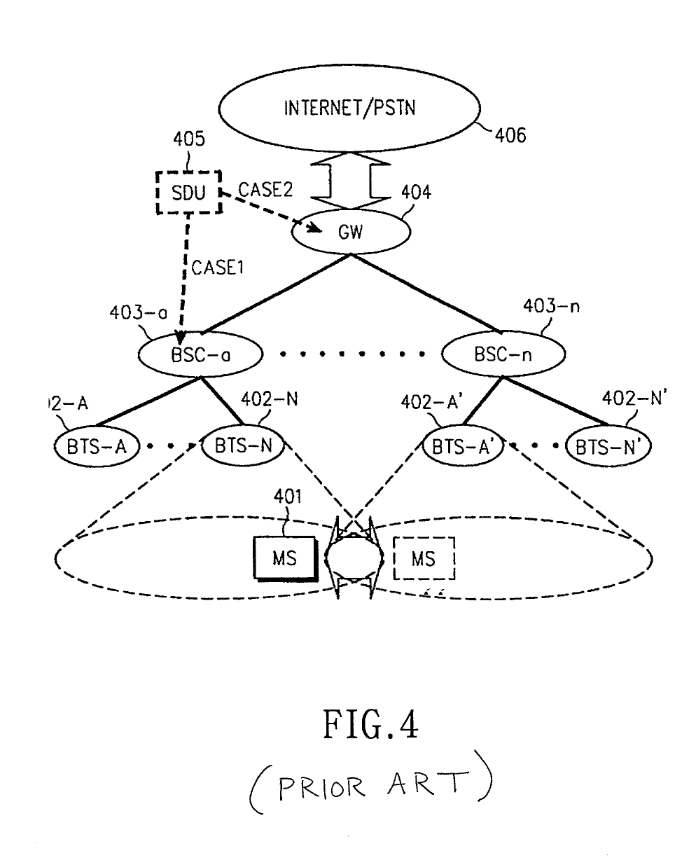

FIG. 4 illustrates a network configuration for a typical mobile communication system. This network architecture is common to IS-95A/B, GSM, IS-2000, WCDMA, and UMTS except that components are labeled with different names.

Referring to FIG. 4, an MS 401, operating as a mobile communication terminal, is either a legacy terminal that does not support IP or an IP terminal. BTSs 402-A to 402-N and 402-A′ to 402-N′ manage radio resources and exchange information with MSs on radio links. The BTSs also support signal protocols such as call set-up or call release. A GW 404 connects the mobile communication network to an Internet/PSTN 406 and supports protocol conversion between different networks. An SDU 405 unifies the same information received from a plurality of links and delivers the unified information to an upper layer, when an MS communicates with at least two BTSs simultaneously as in soft handoff. The SDU 405 may be located at a BSC or the GW 404 from a physical aspect, and at any place in the mobile communication network from a logical aspect, as long as the place is the connection point of at least two links established for the same MS. For convenience's sake, the following description is made assuming that the SDU 405 resides in a BSC.

In the above mobile communication network, BSC-BTS links and GW-BSC links may operate on a circuit-switched network using dedicated circuits like E1/T1, or on an IP packet network using IP routers. IP is used at a transport layer while the BSCs are linked to the BTSs by E1/T1 in the former case, while the BSCs are linked to the BTSs using equipment like routers connected to the IP network, not directly on a one-to-one basis in the latter case. The present invention applies to both cases transparently on the premise that an IP is used as an upper layer transmission protocol irrespective of a circuit-switched network or a packet network. While the present is applicable to GSM, WCDMA, UMTS, GPRS, etc., it will be described in the context of IS-2000 addressing communications through node names like BSC, BTS, and so on.

A method of supporting the soft handoff of voice and data transmitted over the Internet or the PSTN by additionally providing some SDU and BTS functions to the above mobile communication network will be descried hereinbelow. The soft handoff method is implemented in a base station (BS) including a BSC and a BTS, independently of an MS. Accordingly, a soft handoff scheme using packet transmission technology can be explored for application to the MS, which is beyond the scope of the present invention.

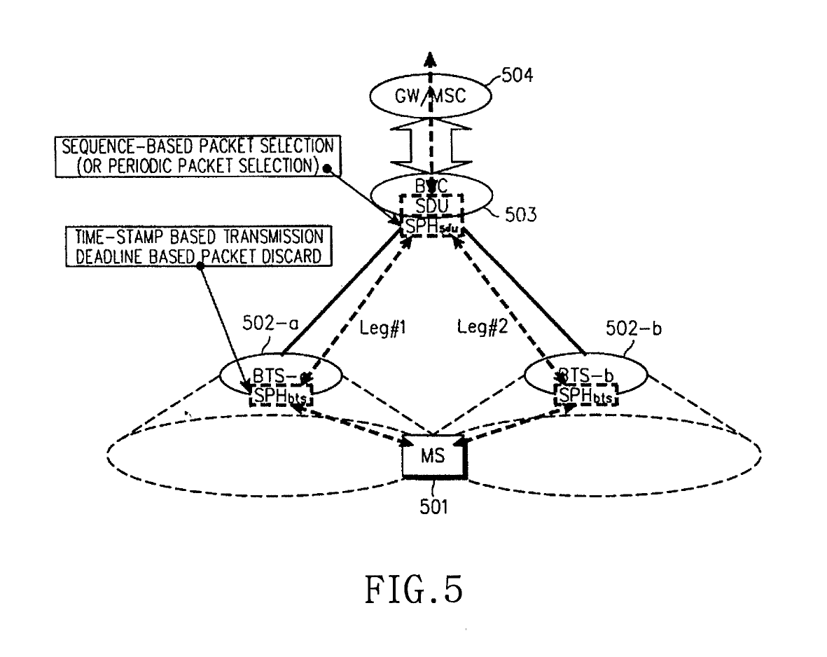

FIG. 5 illustrates a network configuration of a mobile communication system according to an embodiment of the present invention. Referring to FIG. 5, an SDU is provided with an SPHsdu (Soft Packet Handoff module at SDU/BSC) and a BTS is provided with an SPHbts (Soft Packet Handoff module at BTS). A BSC is used in the same sense as an SPHsdu, and a BTS is used in the same sense as an SPHbts in the following description.

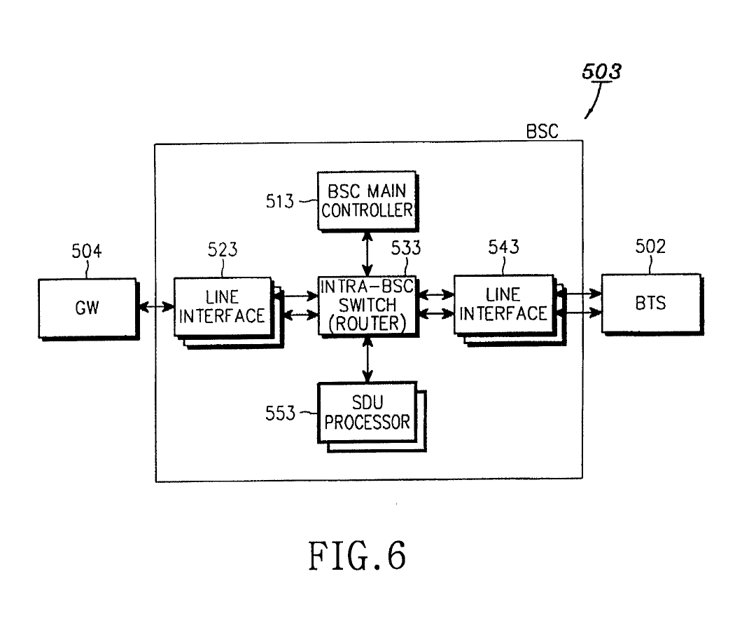

FIG. 6 is a detailed block diagram of a BSC 503 in the mobile communication network illustrated in FIG. 5. Referring to FIG. 6, the BSC 503 is comprised of a BSC main controller 513, a first line interface 523, a second line interface 543, an intra-BSC switch (or a router) 533, and an SDU processor 553. The BSC main controller 513 provides overall control to the operation of the BSC 503, and manages the resources of the BSC 503 and part of the resources of BTSs at its lower layer. The first line interface 523 interfaces signals between a GW 504 and the BSC 503. The intra-BSC switch 533 routes traffic within the BSC 503. The second line interface 543 interfaces signals between the BSC 503 and a BTS 502. The SDU processor 553 multiplexes/demultiplexes outgoing/incoming traffic to/from at least two links at a soft handoff. That is, the SDU processor 553 delivers traffic to a plurality of BTSs and combines the same data received from an MS via the BTSs.

An SPHsdu can be realized physically using separately procured equipment, but its implementation in software in the SDU processor of the BSC is considered in the embodiment of the present invention due to simple implementation and low requirements for processing power and memory capacity, which means that a traditional module can be reused.

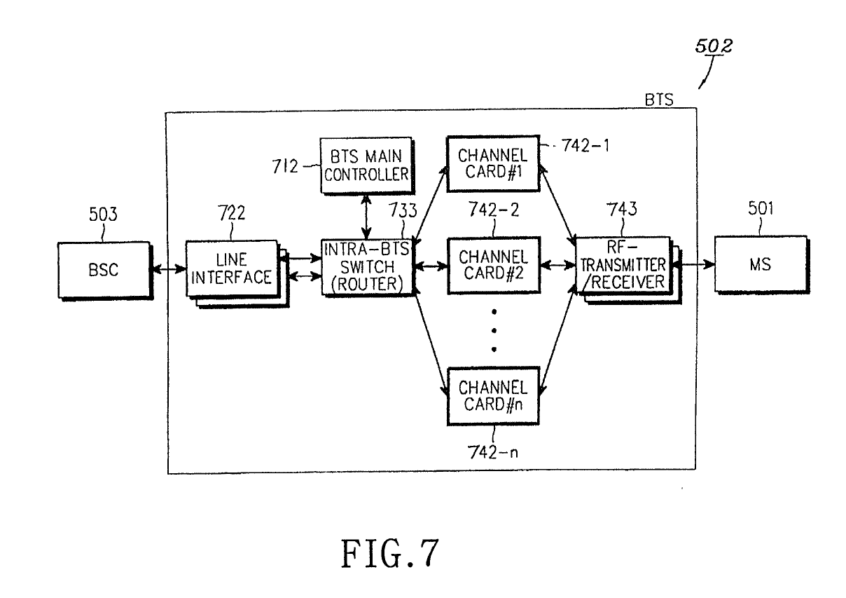

FIG. 7 is a detailed block diagram of the BTS 502 illustrated in FIG. 6 with the same structure as BTSs 502-a and 502-b illustrated in FIG. 5. Referring to FIG. 7, the BTS 502 is comprised of a BTS main controller 712, a line interface 722, an intra-BTS switch (or a router) 733, channel cards 742-1 to 742-n, and an RF (Radio Frequency) transmitter/receiver 743. The BTS main controller 712 provides overall control to the operation of the BTS 502 and manages the resources of the BTS 502. The line interface 722 interfaces signals between the BSC 503 and the BTS 502. The intra-BTS switch 733 routes traffic within the BTS 502. The channel cards 742-1 to 742-n encode and spread transmission data destined for the MS 501, and despread and decode signals received from the MS 501. The RF transmitter/receiver 743 upconverts the frequency of signals from the channel cards 742-1 to 742-n, for transmission and downconverts the frequency of signals received from the MS 501 prior to transmission to corresponding channel cards.

An SPHbts can be realized physically using separately procured equipment, but its implementation in software in a channel card of the BTS is considered in the embodiment of the present invention due to simple implementation and low requirements for processing power and memory capacity, which means that a traditional module can be reused.

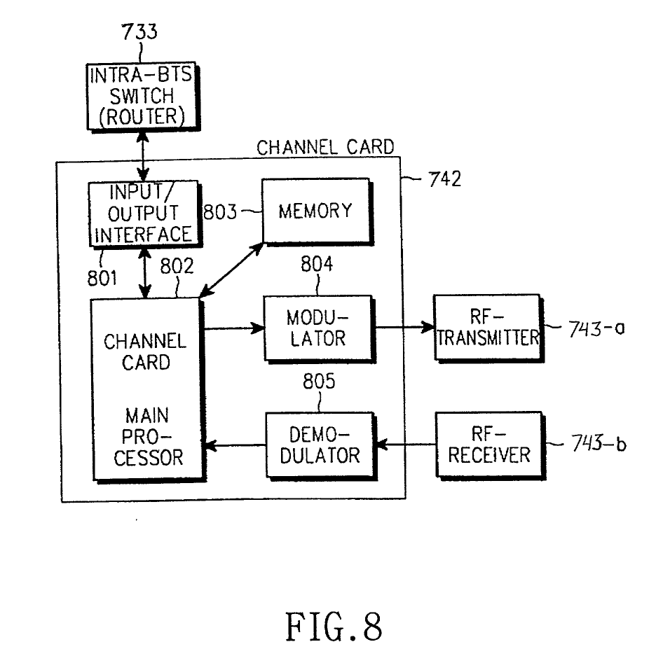

FIG. 8 is a detailed block diagram of a channel card 742 with same structure as the channel cards 742-1 to 742-n illustrated in FIG. 7. Referring to FIG. 8, the channel card 742 is comprised of an input/output interface 801, a channel card main processor 802, a memory 803, a modulator 804, and a demodulator 805. The input/output interface 801 interfaces signals between the switch 733 illustrated in FIG. 7 and the channel card 742. The memory 803 stores program data needed to control the operation of the channel card 742 and temporary data generated during program execution. The modulator 804 encodes and spreads data received from the channel card main processor 802 and feeds spread data to an RF transmitter 743-a. The demodulator 805 despreads and decodes signals received from an RF receiver 743-b and feeds the decoded signals to the channel card main controller 802.

The SPHbts is operated basically by the main processor 802 of the channel card 742 and information related with control of the SPHbts is stored in the memory 803.

In operation, a BS (BSC/SDU and BTS) provides the following six mode options.

(1) TR-Tx mode: Transparent mode (a first mode);

(2) TF-Tx mode: Time-stamp based fixed synchronous transmission mode (a second mode);

(3) TG-Tx mode: Time-stamp based gap synchronous transmission mode (a third mode);

(4) DT-Tx mode: Deadline based time-limited transmission mode (a fourth mode);

(5) TFwtDT-Tx mode: Both Time-stamp based fixed synchronous transmission and deadline based transmission mode (a fifth mode); and

(6) TGwtDT-Tx mode: Both Time-stamp based gap synchronous transmission and deadline based transmission mode (a sixth mode).

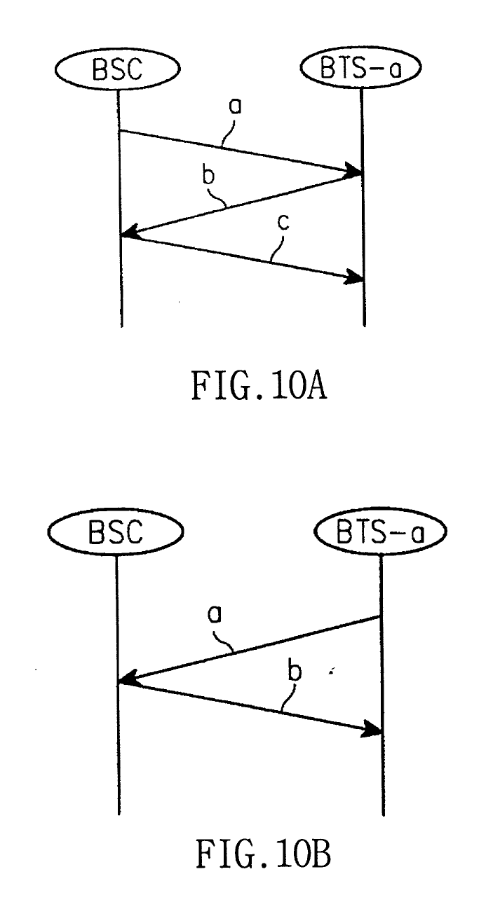

The BSC/SPHsdu and the BTS/SPHbts choose one of the above six modes. How to choose a mode will be described later with reference to negotiation procedures illustrated in FIGS. 10A and 10B.

In the present invention, the above operating modes are used in combination with an SEQ scheme using mode and a non-SEQ scheme mode. In an SEQ scheme, a sequence number is inserted to the header of a packet transmitted via a protocol layer of the present invention. The sequence numbering is designed to facilitate packet reception at the BSC/SPHsdu and reduce traffic delay. To support the SEQ scheme, the BSC/SPHsdu and the BTS/SPHbts have memories to manage transmission sequence numbers (Tx-SEQs) and reception sequence numbers (Rx-SEQs). When transmitting a packet to the BTS/SPHbts, the BSC/SPHsdu writes a Tx-SEQ in the header of the packet and increases the Tx-REQ stored in its memory. The same thing occurs in the BTS/SPHbts.

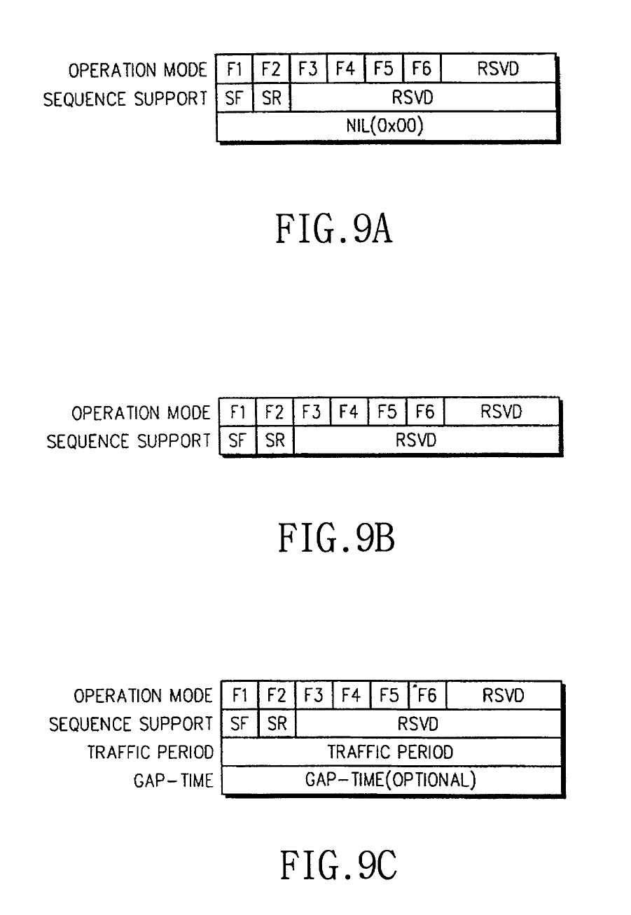

The BSC/SPHsdu and the BTS/SPHbts determine an operating mode to be used and whether to support the SEQ scheme or not by negotiations. FIGS. 9A, 9B and 9C illustrate control messages related to negotiations.

FIG. 9A illustrates a Configuration Request message. By the Configuration Request message, the BSC/SPHsdu notifies the BTS/SPHbts of its supporting function and requests the BTS/SPHbts to report a function supported by the BTS/SPHbts to the SPHsdu, and vice versa depending on the transmission direction of the message. The Configuration Request message includes the following fields.

### Operation Mode fields

F1: set to 1 to support the TR-Tx mode and otherwise, set to 0;

F2: set to 1 to support the TF-Tx mode and otherwise, set to 0;

F3: set to 1 to support the TG-Tx mode and otherwise, set to 0;

F4: set to 1 to support the DT-Tx mode and otherwise, set to 0;

F5: set to 1 to support the TFwtDT-Tx mode and otherwise, set to 0; and

F6: set to 1 to support the TGwtDT-Tx mode and otherwise, set to 0.

### Sequence Support Fields

SF: set to 1 if the SEQ scheme is desired for packet transmission from the BSC/SPHsdu to the BTS/SPHbts and otherwise, set to 0; and

SR: set to 1 the SEQ scheme is desired for packet transmission from the BTS/SPHbts to the BSC/SPHsdu and otherwise, set to 0.

RSVD and NIL fields are not currently used but reserved for future use.

FIG. 9B illustrates a Configuration Response message. With the Configuration Response message, the BSC/SPHsdu or the BTS/SPHbts notifies the other party of its supporting function. The Configuration Response message includes the same message fields as the Configuration Request message, except that the NIL field is omitted.

FIG. 9C illustrates a Configuration Confirm message. With the Configuration Confirm message, the BSC/SPHsdu transmits ultimate information about a mode to be used for communication and whether the SEQ scheme is used or not to the SBTS/SPHbts. The Configuration Confirm message includes two new fields as follows in addition to the fields of the Configuration Response message.

### Traffic Period Field (in ms)

It denotes a traffic generation/processing period. In a general data service, the Traffic Period is set to an appropriate value considering the capacities of the BSC and the BTS. For voice service, a voice packet generation period is set in the Traffic Period field. For example, the Traffic Period is set to 20 ms in IS-95 and IS-2000 when Q-CELP (Qualcomm-Code Excited Linear Prediction) and EVRC (Enhanced Variable Rate CODEC) are used.

### Gap-Time (in ms)

This field is used when the BSC/SPHsdu and the BTS/SPHbts choose the TG-Tx mode or the TGwtDT-Tx mode. The BTS/SPHbts delays traffic received from the BSC/SPHsdu for a time period set in Gap-Time before transmission in the air. The specific usage of Gap-Time will be described later in connection with each mode.

FIGS. 10A and 10B illustrate negotiations between the BSC/SPHsdu and the BTS/SPHbts according to the embodiment of the present invention. The negotiations are carried out as illustrated in FIG. 10A when a configuration request is originated from the network (the high layer system above the BSC/SPHsdu) and as illustrated in FIG. 10B when a configuration request is originated from an MS.

Referring to FIG. 10A, the BSC/SPHsdu sends a Configuration Request message as illustrated in FIG. 9A to the BTS/SPHbts, notifying its supporting function and requesting notification of a function supported by the BTS/SPHbts in step a. Then, the BTS/SPHbts sends a Configuration Response message as illustrated in FIG. 9B to the BSC/SPHsdu in response to the Configuration Request message, notifying its supporting function in step b. Upon receipt of the Configuration Response message as illustrated in 9C, the BSC/SPHsdu sends the BTS/SPHbts a Configuration Confirm message containing information about a mode to be used for communication and whether the SEQ scheme is to be used or not in step c.

Referring to FIG. 10B, the BTS/SPHbts sends a Configuration Request message to the BSC/SPHsdu, notifying its supporting function and requesting notification of a function supported by the BSC/SPHsdu in step a. Then, the BSC/SPHsdu sends a Configuration Response message to the BTS/SPHbts in response to the Configuration Request message, notifying its supporting function in step b. In the negotiation procedures illustrated in FIGs. 10A and 10B, the BSC/SPHsdu and the BTS/SPHbts choose one of the six operation modes and determine whether the SEQ scheme is to be used or not.

If the network is so configured that BSC/SPHsdu and the BTS/SPHbts are operated with the same mode among the six operation, the above negotiation procedures become obsolete. This is system implementation-dependent.

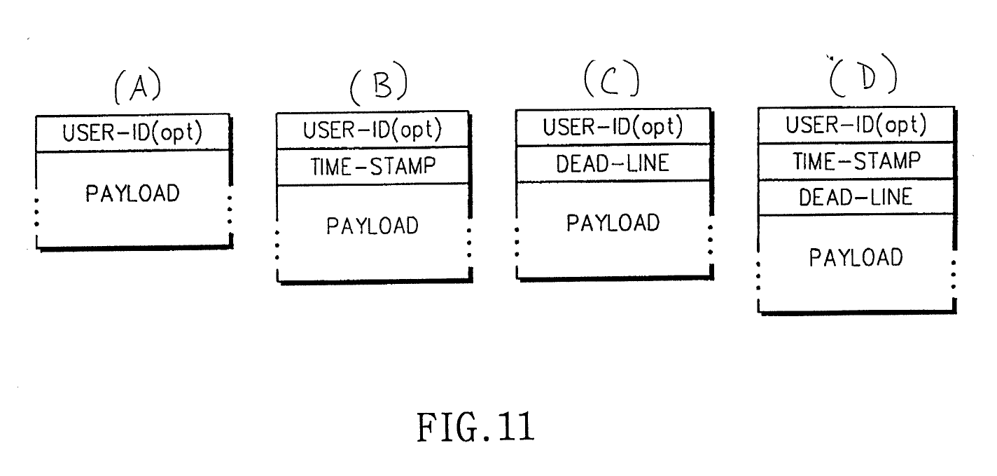

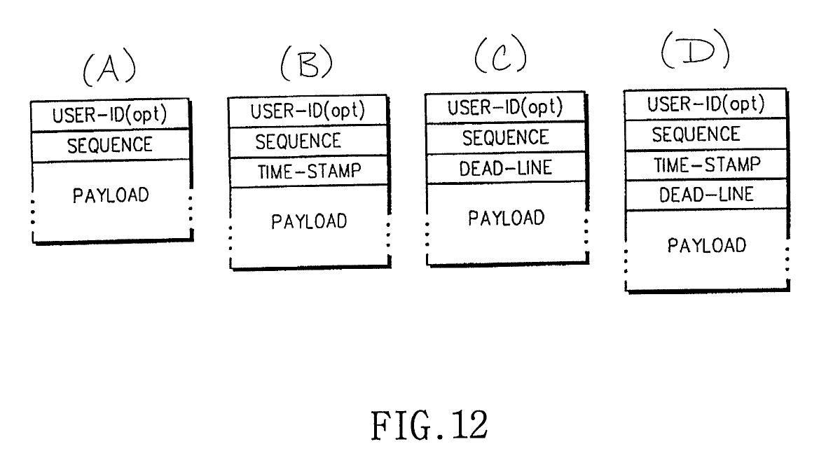

FIGS. 11A to 11D illustrate the structures of packets in the case of using the SEQ scheme and FIGS. 12A to 12D illustrate the structures of packets in the case of not using the SEQ scheme, under the same conditions. While a User-ID field is unnecessary when a user is identified in a lower-layer protocol in the present invention, it is inserted if the lower-layer protocol cannot identify a user. In other words, the User-ID field is optional depending on the operation of the lower-layer protocol.

For forward transmission from the BSC/SPHsdu to the BTS/SPHbts, frames illustrated in FIGS. 11A and 12A are used in the TR-Tx mode, frames illustrated in FIGs. 11B and 12B in the TF-Tx mode and TG-Tx mode, frames illustrated in FIGS. 11C and 12C in the DT-Tx mode, and frames illustrated in FIGs. 11D and 12d in the TFwtDT-Tx mode and TGwtDT-Tx mode. For reverse transmission from the BTS/SPHbts to the BSC/SPHsdu, the frames shown in FIGS. 11A and 12A are used.

How the BSC/SPHsdu and the BTS/SPHbts operate in each mode will be described considering transmission on the forward link and the reverse link, separately.

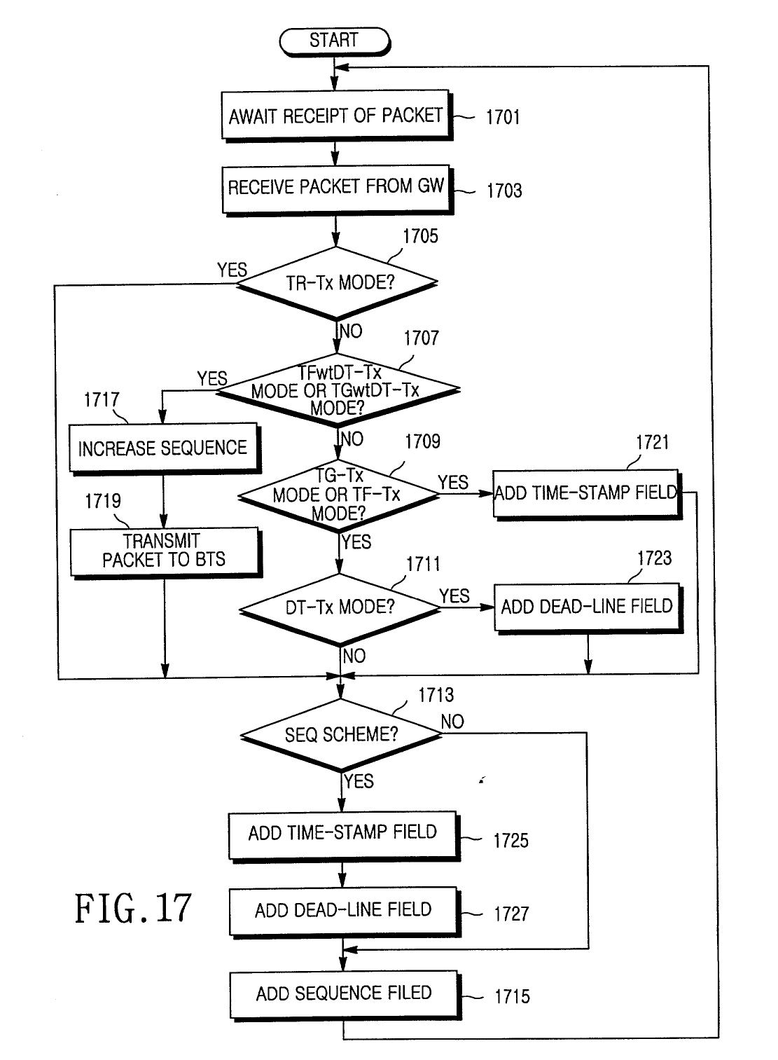

FIG. 17 is a flowchart illustrating packet processing for forward packet transmission in the BSC/SPHsdu according to the embodiment of the present invention. The forward packet transmission in each mode will be specified later.

Referring to FIG. 17, the BSC/SPHsdu awaits receipt of a packet from the GW 504 in step 1701 and receives a packet from the GW 504 in step 1703. In step 1705, the BSC/SPHsdu checks whether the current operation mode is the TR-Tx mode. In the case of the TR-Tx mode, the BSC/SPHsdu determines whether the SEQ scheme is to be used or not in step 1713. If it is not the TR-Tx mode, the BSC/SPHsdu determines whether the current operation mode is either the TFwtDT-Tx mode or the TGwtDT-Tx mode in step 1707.

If the current operation mode is either the TFwtDT-Tx mode or the TGwtDT-Tx mode, the BSC/SPHsdu adds a Time-Stamp field and a Dead-Line field to the received packet in steps 1721 and 1723. Then, the BSC/SPHsdu proceeds to step 713. The action time of the packet, that is, the time at which the packet is transmitted on a radio link is written in the Time-Stamp field, and the waiting time of the packet due to lack of an available radio link is written in the Dead-Line field. If the current operation mode is not either the TFwtDT-Tx mode or the TGwtDT-Tx mode in step 1707, the BSC/SPHsdu determines whether it is either the TG-Tx mode or the TF-Tx mode in step 1709. If the current operation mode is one of the TG-Tx mode and the TF-Tx mode, the BSC/SPHsdu adds the Time-Stamp field to the received packet in step 1725 and proceeds to step 713. If the current mode is not either the TG-Tx mode or the TF-Tx mode in step 1709, the BSC/SPHsdu determines whether it is the DT-Tx mode in step 1711.

In the case of the DT-Tx mode, the BSC/SPHsdu adds the Dead-Line field to the received packet in step 1727 and proceeds to step 1713. If the current operation mode is not the DT-Tx mode in step 1711, the BSC/SPHsdu directly determines whether the SEQ scheme is to be used or not in step 1713. If the SEQ scheme is supposed to be used, the BSC/SPHsdu adds a Sequence field to the received packet, reads a TX-SEQ from its memory, and writes it in the Sequence field in step 1715, increases the TX-SEQ stored in the memory in step 1717, and proceeds to step 1719. If the SEQ scheme is not to be used, the BSC/SPHsdu jumps to step 1719 where it transmits the received packet and returns to step 1701 to await packet reception.

Now, a description will be made of forward packet transmission in each mode at a soft handoff. In soft handoff, the BSC/SPHsdu sends a packet on two links (i.e. to two BTSs) that provide a service to a particular MS, and the two BTSs send data received from the MS to the BSC/SPHsdu.

### First mode (TR-Tx mode)

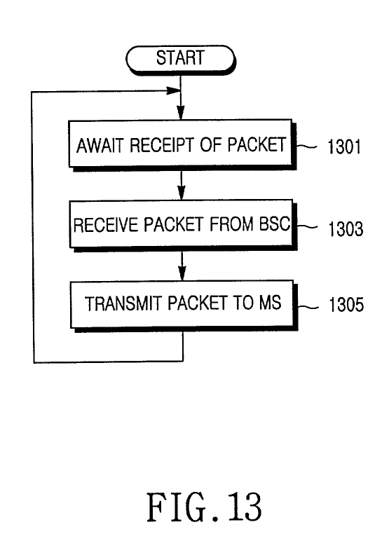

FIG. 13 is a flowchart illustrating a control operation for forward packet transmission in the TR-Tx mode in the BTS/SPHbts according to the embodiment of the present invention. The TR-Tx mode refers to a mode in which a packet is transmitted transparently without any modification.

Referring to FIG. 13, the BTS/SPHbts awaits receipt of a packet from the BSC/SPHsdu in step 1301 and receives a packet from the BSC/SPHsdu in step 1303. Then, the BTS/SPHbts sends the received packet without any modification to an MS in step 1305. In the TR-Tx mode, the BSC/SPHsdu delivers a packet received from the GW to the BTS-a/SPHbts and the BTS-b/SPHbts with no modification made to the packet. In turn, the BTS-a/SPHbts and the BTS-b/SPHbts send the received packets to the MS with no modification made to the packets either.

### Second Mode (TF-Tx mode)

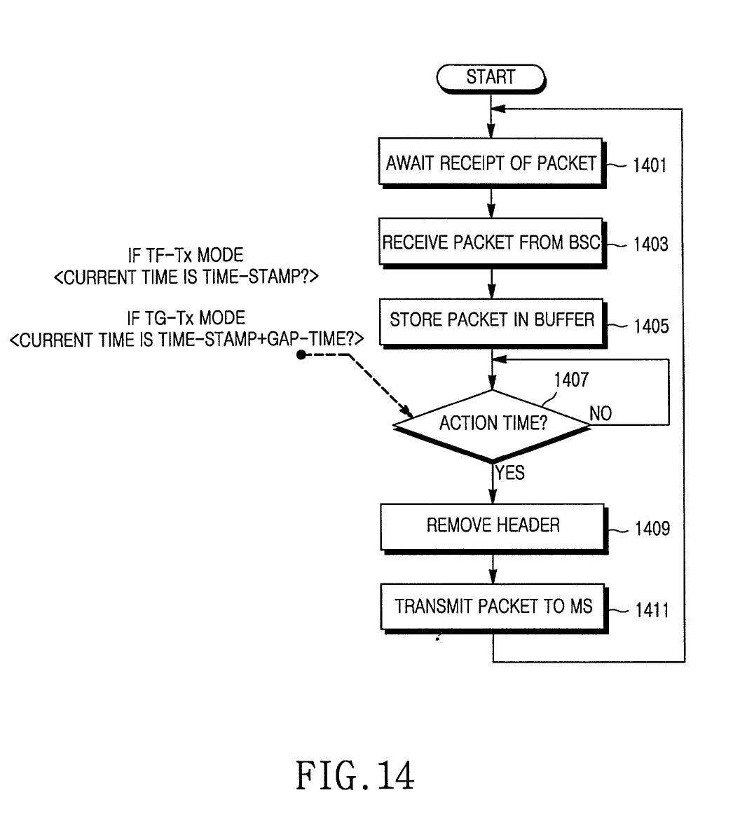

FIG. 14 is a flowchart illustrating a control operation for forward packet transmission in the TF-Tx mode and the TG-Tx mode in the BTS/SPHbts according to the embodiment of the present invention. The TF-Tx mode is available when the same information should be received from a plurality of BTSs at the same time as in a legacy terminal.

Referring to FIG. 14, the BTS/SPHbts awaits receipt of a packet from the BSC/SPHsdu in step 1401 and receives a packet from the BSC/SPHsdu in step 1403. The BTS/SPHbts stores the received packet in its internal buffer in step 1405. In step 1407, the BTS/SPHbts determines whether it is time to transmit the packet on a radio link by checking the Time-Stamp field of the packet. At the action time, the BTS/SPHbts removes the header from the stored packet in step 1409 and transmits the header-removed packet to the MS on the radio link in step 1411. If it is not time to transmit the packet in step 1407, the BTS/SPHbts waits until the action time.

In the TF-Tx mode, the BSC/SPHsdu writes the action time of a packet received from the GW in the Time-Stamp field and transmits the packet to the BTS-a and the BTS-b. Then, the BTSs buffer the received packets and transmit them at the action time set in the Time-Stamp field to the MS on the radio links.

### Third Mode (TG-Tx mode)

The TG-Tx mode is also available when the same information should be received from a plurality of BTSs at the same time, as in a legacy terminal. The TG-Tx mode differs from the TF-Tx mode in that a packet should be transmitted after the sum of an action time set in its Time-Stamp field and a gap time negotiated at connection establishment.

Referring to FIG. 14 again, the BTS/SPHbts awaits receipt of a packet from the BSC/SPHsdu in step 1401 and receives a packet from the BSC/SPHsdu in step 1403. The BTS/SPHbts stores the received packet in its internal buffer in step 1405. In step 1407, the BTS/SPHbts determines whether it is time to transmit the packet by checking an action time set in the Time-Stamp field and a pre-negotiated gap time. The BTS/SPHbts calculates the actual action time of the packet by adding the action time and the gap time. At the actual action time, the BTS/SPHbts removes the header from the stored packet in step 1409 and transmits the header-removed packet to the MS on a radio link in step 1411. If it is not time to transmit the packet in step 1407, the BTS/SPHbts waits until the actual action time.

In the TG-Tx mode, the BSC/SPHsdu writes the action time of a packet received from the GW in the Time-Stamp field and transmits the packet to the BTS-a and the BTS-b. Then, the BTSs buffer the received packets and transmit them to the MS on the radio links after the sum of the pre-negotiated gap time and the action time.

### Fourth Mode (DT-Tx mode)

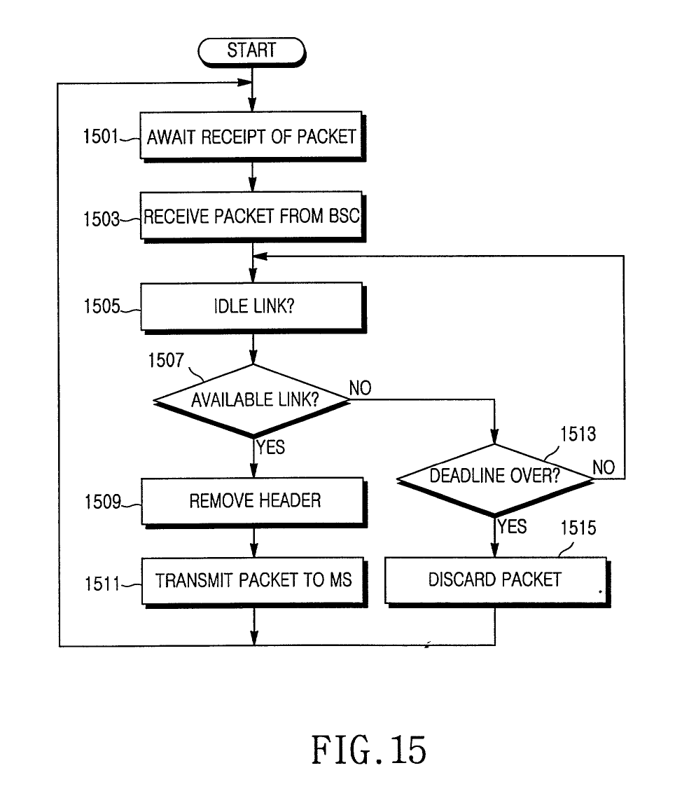

FIG. 15 is a flowchart illustrating a control operation for forward packet transmission in the DT-Tx mode in the BTS/SPHbts according to the embodiment of the present invention. The DT-Tx mode is useful in the case where time-sensitive traffic such as voice is delayed and thus should be discarded.

Referring to FIG. 15, the BTS/SPHbts awaits receipt of a packet from the BSC/SPHsdu in step 1501 and receives a packet from the BSC/SPHsdu in step 1503. The BTS/SPHbts checks whether there is an available radio link in step 1507. If an available radio link exists, the BTS/SPHbts removes the header from the received packet in step 1509 and transmits the header-removed packet to the MS in step 1511. On the other hand, if there is no available radio link, the BTS/SPHbts stores the received packet in its buffer and checks whether a maximum waiting time allowed to the packet for transmission, set in the Dead-Line field of the packet has expired in step 1513. At timeout expiration, the BTS/SPHbts discards the stored packet in step 1515. If the maximum waiting time has not expired yet, the BTS/SPHbts returns to step 1507.

The DT-Tx mode prevents transmission of untimely time-sensitive traffic on a radio link. It also prevents lengthy transmission and buffering of a useless packet from spoiling successive packets. In the DT-Tx mode, the BSC/SPHsdu writes a maximum time allowed to a packet that waits for transmission on a radio link in its Dead-Line field and transmits it to the BTS-a/SPHbts and the BTS-b/SPHbts. Then, the BTS-a/SPHbts and the BTS-b/SPHbts make efforts to send the received packets before the time specified in the Dead-Line field, and if they fail, they discard the packets.

### Fifth Mode (TFwtDT-Tx Mode) and Sixth Mode (TGwtDT-Tx Mode)

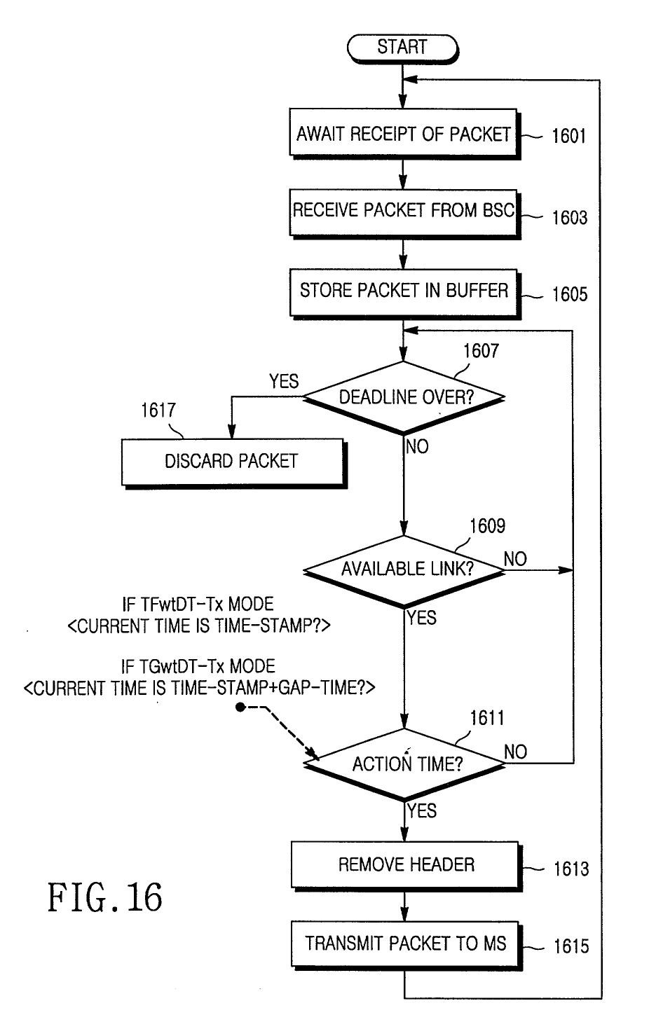

FIG. 16 is a flowchart illustrating a control operation for forward packet transmission in the TFwtDT-Tx mode and the TGwtDT-Tx mode in the BTS/SPHbts according to the embodiment of the present invention. The TFwtDT-Tx mode supports the TF-Tx mode and the DT-Tx mode in combination, and the TGwtDT-Tx mode support the TG-Tx mode and the DT-Tx mode in combination.

Referring to FIG. 16, the BTS/SPHbts awaits receipt of a packet from the BSC/SPHsdu in step 1601 and receives a packet from the BSC/SPHsdu in step 1603. The BTS/SPHbts stores the received packet in its internal buffer in step 1605 and checks whether a maximum waiting time allowed to the packet that waits for transmission, set in its Dead-Line field has expired in step 1607. At timeout expiration, the BTS/SPHbts discards the stored packet in step 1617. If the time set in the Dead-Line field has not expired yet, the BTS/SPHbts proceeds to step 1609. In step 1609, the BTS/SPHbts checks whether there is an available radio link. If an available radio link exists, the BTS/SPHbts proceeds to step 1611. On the other hand, if there is no available radio link, the BTS/SPHbts returns to step 1607.

In step 1611, the BTS/SPHbts determines whether it is time to transmit the packet on a radio link. The packet is transmitted at the time set in the TimeStamp field of the packet in the TFwtDT-Tx mode, whereas it is transmitted after the sum of the time set in the Time-Stamp field and a pre-negotiated gap time. At the actual action time, the BTS/SPHbts removes the header from the stored packet in step 1613 and transmits the header-removed packet to the MS on a radio link in step 1615. If it is not time to transmit the packet in step 1611, the BTS/SPHbts returns to step 1607.

In the TFwtDT-Tx mode and the TGwtDT-Tx mode, the BSC/SPHsdu writes the action time of a packet received from the GW in the Time-Stamp field and a maximum waiting time allowed to the packet for transmission in the Dead-Line field of the packet, and transmits the packet to the BTS-a and the BTS-b. Then, the BTSs buffer the received packets and transmit them based on the time set in the Time-Stamp field. If the BTSs fail to transmit the packets until the maximum waiting time set in the Dead-Line field expires, they discard the packets.

Now, packet processing for reverse packet transmission in the BSC/SPHsdu and the BTS/SPHbts will be described.

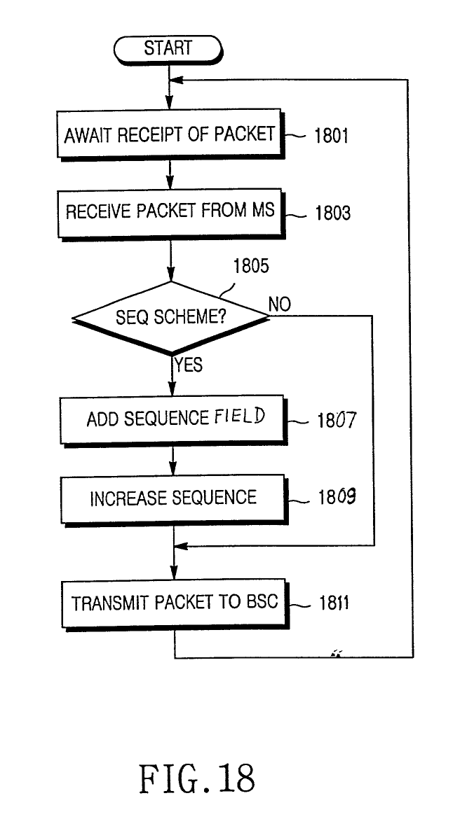

FIG. 18 is a flowchart illustrating a control operation for reverse packet transmission in the BTS/SPHbts according to the embodiment of the present invention. Referring to FIG. 18, the BTS/SPHbts awaits receipt of a packet in step 1801 and receives a packet from an MS in step 1803. In step 1805, the BTS/SPHbts determines whether the SEQ scheme has been set. If it has, the BTS/SPHbts adds a Sequence field containing an Rx-SEQ to the received packet in step 1807 and increases the Rx-SEQ stored in its memory in step 1809 and proceeds to step 1811. On the other hand, if the SEQ scheme has not been set, the BTS/SPHbts proceeds directly to step 1811. In step 1811, the BTS/SPHbts transmits the packet to the BSC/SPHsdu.

In reverse transmission, the BTS/SPHbts delivers a packet received from the MS transparently to the BSC/SPHsdu. If the SEQ scheme is supported, the BTS/SPHbts adds a Sequence field to the header of the received packet prior to transmission. For reverse transmission, the BTS/SPHbts operates in two modes depending on whether the SEQ scheme is supported or not. In a first mode not using the SEQ scheme, the BTS/SPHbts carries out periodical packet transmission. The periodic operation may cause processing load like periodic interrupts and entails packet storing until a transmission time, thereby increasing time delay. At a second mode using the SEQ scheme, time delay is avoided but the addition of the Sequence header field may decrease a transmission band.

### First Mode (Periodic Operation)

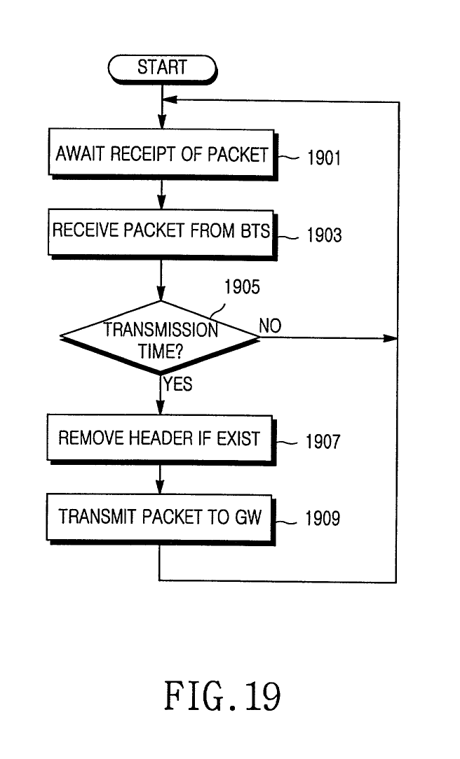

FIG. 19 is a flowchart illustrating a reverse packet processing operation at the first mode not using the SEQ scheme in the BSC/SPHsdu according to the embodiment of the present invention.

Referring to FIG. 19, the BSC/SPHsdu awaits receipt of a packet in step 1901, and receives a packet from at least one BTS and stores it in its internal buffer in step 1903. In step 1905, the BSC/SPHsdu determines whether the current time is a preset transmission time. If it is, the BSC/SPHsdu proceeds to step 1907 and otherwise, it returns to step 1901 to receive another packet. In step 1907, the BSC/SPHsdu checks errors in stored packets and removes headers from error-free packets. The BSC/SPHsdu sends the header-removed packets to the GW and discards the other packets in step 1909.

In the first mode not using the SEQ scheme, the BSC/SPHsdu, from which a packet is branched to BTSs during a soft handoff, monitors information received from at least two legs periodically and delivers error-free information to the GW. The BSC/SPHsdu processes reverse traffic periodically. Here, a traffic period can be assigned depending on services by the application layer of the mobile communication system. For example, the traffic generation period of Q-CELP/EVRC, 20 ms can be set as the traffic period in IS-95A/B and IS-2000.

At a soft handoff, the BSC/SPHsdu, if it receives packets from at least two legs, stores them in its buffer. When it is time to transmit packets according to the traffic processing period, the BSC/SPHsdu performs an error check on the packets. The BSC/SPHsdu sends one error-free packet to the GW and discards the other packets. The error check, of which the description is beyond the scope of the present invention, is assumed to be supported by a lower-layer protocol. If the lower-layer protocol is so configured that an error-having frame is discarded, the BSC/SPHsdu sends an error-free packet received from the lower-layer protocol to the GW at a corresponding transmission time.

### Second Mode (using SEQ Scheme)

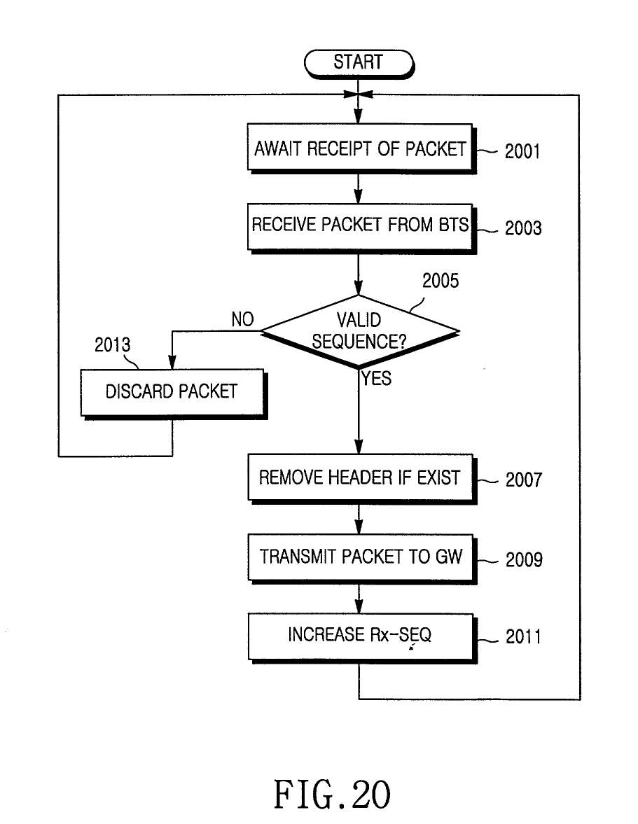

FIG. 20 is a flowchart illustrating a non-periodic reverse packet processing operation at the second mode using the SEQ scheme in the BSC/SPHsdu according to the embodiment of the present invention.

Referring to FIG. 20, the BSC/SPHsdu awaits receipt of a packet in step 2001, and receives a packet from at least one BTS and stores it in its internal buffer in step 2003. In step 2005, the BSC/SPHsdu determines whether a sequence number set in the Sequence field of the header of the packet is valid or not. That is, the BSC/SPHsdu determines whether the received packet has been already delivered to an upper-layer system (GW) referring to an Rx-SEQ stored in its memory in order to prevent repeated delivery of the same packet to the higher layer because a packet from the same MS can be received from at least two BTSs at a soft handoff. If the sequence number is valid, the BSC/SPHsdu proceeds to step 2007. If it is not valid, the BSC/SPHsdu discards the packet in step 2013 and returns to step 2001 to receive another packet. The BSC/SPHsdu removes a header from the packet in step 2007 and delivers the header-removed packet to the GW in step 2009. In step 2011, the BSC/SPHsdu increases the Rx-SEQ stored in the memory by 1.

In the second mode, the BSC/SPHsdu checks the sequence number of a received packet. If the sequence number of the packet is different from an Rx-SEQ stored in the memory, the BSC/SPHsdu sends the packet to the GW and updates the Rx-SEQ to the sequence number of the received packet. On the other hand, if the Rx-SEQ is identical to the sequence number of the packet, the BSC/SPHsdu discards the packet. The basic difference between the first mode and the second mode is that while the BSC/SPHsdu processes received packets periodically in the first mode, it processes packets each time they are received in an event-driven manner in the second mode. Accordingly, the second mode is readily implemented despite the shortcoming of decreased trunk efficiency due to addition of the Sequence field in the header of a packet.

The above description has been made basically assuming that the SPHsdu is synchronized to the SPHbts. Synchronization may be made by an external entity like a GPS (Global Positioning System) or by a standardization protocol such as an NSP (Network Services Protocol).

As described above, the present invention effectively supports the soft handoff of packet voice and packet data services regardless of link direction and regardless of using a legacy terminal or a future IP terminal in a wireless mobile communication network using packet-based transmission technology. Furthermore, the present invention operates independently of a lower-layer protocol. Due to the flexibility permitting expansion and selection of various functions, the present invention enables use of traditional terminals without modifications in a future mobile communication system using IP packet transmission technology.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A packet service method for a base station controller (BSC) in a mobile communication system, comprising the steps of:
receiving a packet to be transmitted for a mobile station (MS);
adding a field containing time information necessary for packet transmission on a radio link to the received packet; and
transmitting the packet including the field to a base station transceiver sub-system (BTS).

2. The packet service method of claim 1, further comprising the steps of:
determining whether a sequence number is to be used for the packet transmission; and
adding a field containing the sequence number of the packet to the packet if it is determined that the sequence number is to be used.

3. The packet service method of claim 1, wherein the time information is an action time when the packet is to be transmitted on the radio link.

4. The packet service method of claim 1, wherein the time information includes an action time when the packet is to be transmitted on the radio link and a waiting time for which the packet waits to be transmitted until there is an available radio link.

5. A packet service method for a base station transceiver sub-system (BTS) in a mobile communication system, comprising the steps of:
storing a packet received from a base station controller (BSC);
determining whether a current time is an action time when the received packet is to be transmitted based on time information set in a predetermined field of the packet; and
transmitting the packet to a mobile station (MS) on a radio link if the current time is an action time.

6. The packet service method of claim 5, wherein the action time is a time set in the predetermined field of the packet. .

7. The packet service method of claim 5, wherein the action time is sum of a time set in the predetermined field of the packet and a pre-negotiated time.

8. A packet service method for a base station transceiver sub-system (BTS) in a mobile communication system, comprising the steps of:
storing a packet received from a base station controller (BSC);
determining whether there is a available radio link;
transmitting the packet to a mobile station(MS) on a radio link if there is a available radio link;
determining whether a waiting time set in a predetermined field of the packet has expired if there is no available radio link; and
discarding the packet if the waiting time has expired and determining whether there is an available radio link if the waiting time has not expired.

9. A packet service method for a base station transceiver sub-system (BTS) in a mobile communication system, comprising the steps of:
storing a packet received from a base station controller (BSC);
determining whether a waiting time set in a predetermined field of the packet has expired;
discarding the packet if the waiting time has expired and determining whether there is an available radio link if the waiting time has not expired;
determining whether the waiting time has expired if there is no available radio link and determining whether the current time is an action time based on the time information if there is an available radio link; and
transmitting the packet to a mobile station (MS) on the radio link at the action time and determining whether the waiting time has expired if the current time is not the action time.

10. The packet service method of claim 9, wherein the action time is sum of a time set in the predetermined field of the packet.

11. The packet service method of claim 9, wherein the action time is sum of a time set in the predetermined field of the packet and a pre-negotiated time.

12. A packet service method for a base station controller (BSC) in a mobile communication system, comprising the steps of:
receiving a packet to be transmitted for a mobile station (MS);
determining whether a sequence number is to be used for the packet;
adding a field containing the sequence number of the packet to the packet if it is determined that the sequence number is to be used; and
transmitting the packet including the field to a base station transceiver sub-system (BTS).

13. A packet service method for a base station transceiver sub-system (BTS) in a mobile communication system, comprising the steps of:
storing a packet received from a mobile station (MS);
determining whether a sequence number is to be used for the packet;
adding a field containing the sequence number of the packet to the packet if it is determined that the sequence number is to be used; and
transmitting the packet including the field to a base station controller (BSC).

14. A packet service method for a base station controller (BSC) in a mobile communication system, comprising the steps of:
storing a packet received from a base station transceiver sub-system (BTS);
determining whether a current time is an action time based on a predetermined period;
checking whether the stored packet has an error at the action time; and
transmitting the packet to a higher layer system if the packet has no errors.

15. A packet service method for a base station controller (BSC) in a mobile communication system, comprising the steps of:
storing a packet received from a base station transceiver sub-system (BTS);
determining whether a sequence of the packet is valid or not by checking a sequence number set in the packet; and
transmitting the packet to a high layer system if the packet sequence is valid and discarding the packet if the packet sequence is invalid.

16. A packet service method in a mobile communication system, comprising the steps of:
adding a field containing time information necessary for packet transmission on a radio link to a packet to be transmitted for a mobile station (MS) in a base station controller (BSC) and transmitting the packet including the field from the BSC to a base station transceiver sub-system (BTS);
storing the packet received from the BSC in the BTS;
determining whether a current time is an action time based on the time information set in the field of the packet in the BTS; and
transmitting the packet from the BTS to the MS on a radio link at the action time.

17. The packet service method of claim 14, wherein the action time is a time set in the field.

18. The packet service method of claim 14, wherein the action time is the sum of a time set in the field and a pre-negotiated time.

19. The packet service method of claim 14, further comprising the step of adding a field containing a sequence number of the packet to the packet in the BSC.

20. The packet service method of claim 14, wherein the time information includes a waiting time for which the packet waits to be transmitted until there is an available radio link, further comprising the step of discarding the packet if the packet is not transmitted until the waiting time expires.

21. A packet service method in a mobile communication system, comprising the steps of:
storing a packet received from a mobile station (MS) in a base station transceiver sub-system (BTS), adding a field containing a sequence number of the packet to the packet in the BTS, and transmitting the packet including the field from the BTS to a base station controller (BSC);
determining whether a sequence of the packet is valid or not by checking the sequence number set in the header of the packet in the BSC; and
transmitting the packet from the BSC to a high layer system if the packet sequence is valid and discarding the packet if the packet sequence is invalid.
